(19) United States
(12) Patent Application Publication
(10) Pub. No.: US 2025/0226902 A1
(43) Pub. Date: Jul. 10, 2025

(54) Method And System For Using An Encoded Audio Stream Within A Digital Radio Broadcasting Chain

(71) Applicant: iBiquity Digital Corporation, Columbia, MD (US)

(72) Inventors: Russell Iannuzzelli, Columbia, MD (US); Jeffrey Detweiler, Columbia, MD (US); William Snelling, Columbia, MD (US)

(21) Appl. No.: 18/724,250

(22) PCT Filed: Dec. 29, 2022
(86) PCT No.: PCT/US2022/082572

§ 371 Date: Jun. 26, 2024

Related U.S. Application Data
(60) Provisional application No. 63/295,467, filed on Dec. 30, 2021.

(51) Int. Cl. H04H 60/07; G10L 19/16; G10L 19/20; H04H 60/90

(52) U.S. Cl. CPC H04H 60/07; G10L 19/167; G10L 19/20; H04H 60/90

(57) ABSTRACT

Embodiments of a method and system for transmitting an audio stream and a digital radio broadcasting system are disclosed. The method comprises providing an audio source remotely located to a digital radio broadcasting system. encoding at the audio source an audio stream with an audio codec resulting in an encoded audio stream, transmitting the encoded audio stream over a computer network to the digital radio broadcasting system. receiving the encoded audio stream and processing the encoded audio stream at the digital radio broadcasting system for broadcast by the digital radio broadcasting system without decoding of the encoded audio stream, and broadcasting the encoded audio stream by the digital radio broadcasting system.

### CLAIM OF PRIORITY

This application is related to and claims priority to U.S. Provisional Application No. 63/295,467, filed on Dec. 30, 2021, and entitled “INCLUSION OF CODEC IN AUDIO CLIENT FOR REDUCED NETWORK BANDWIDTH THUS ALLOWING EFFICIENT REMOTE OPERATION WITH NO TRANSCODING ARTIFACTS”, which is hereby incorporated by reference in its entirety.

### BACKGROUND

Digital radio broadcasting technology delivers digital audio and data services to mobile, portable, and fixed receivers. One type of digital radio broadcasting, referred to as in-band on-channel (IBOC) digital audio broadcasting (DAB), uses terrestrial transmitters in the existing Medium Frequency (MF) and Very High Frequency (VHF) radio bands. HD RadioTM technology, developed by iBiquity Digital Corporation, is one example of an IBOC implementation for digital radio broadcasting and reception. IBOC DAB signals can be transmitted in a hybrid format including an analog modulated carrier in combination with a plurality of digitally modulated carriers. Using the hybrid mode, broadcasters may continue to transmit analog AM and FM simultaneously with higher-quality and more robust digital signals, allowing themselves and their listeners to convert from analog-to-digital radio while maintaining their current frequency allocations.

The HD Radio system allows multiple services to share the broadcast capacity of a single station. One feature of digital transmission systems is the inherent ability to simultaneously transmit both digitized audio and data. Thus, the technology also allows for wireless data services from AM and FM radio stations. First generation (core) services include a Main Program Service (MPS) and the Station Information Service (SIS). Second generation services, referred to as Advanced Application Services (AAS), include information services providing, for example, multicast programming, electronic program guides, navigation maps, traffic information, multimedia programming and other content.

The AAS Framework provides a common infrastructure to support the developers of these services. The AAS Framework provides a platform for a large number of service providers and services for terrestrial radio. It has opened up numerous opportunities for a wide range of services (both audio and data) to be deployed through the system. Thus, the broadcast signals can include metadata, such as the artist, song title, or station call letters. Special messages about events, traffic, and weather can also be included. For example, traffic information, weather forecasts, news, and sports scores can all be scrolled across a radio receiver's display while the user listens to a radio station.

Other types of digital radio broadcasting systems include satellite systems such as Satellite Digital Audio Radio Service (SDARS, e.g., XM Radio™, Sirius®), Digital Audio Radio Service (DARS, e.g., WorldSpace®), and terrestrial systems such as Digital Radio Mondiale (DRM), Eureka 147 (branded as DAB Digital Audio Broadcasting®), DAB Version 2, and FMextra®. As used herein, the phrase “digital radio broadcasting” encompasses digital audio and data broadcasting including in-band on-channel broadcasting, as well as other digital terrestrial broadcasting and satellite broadcasting.

Both AM and FM In-Band On-Channel (IBOC) broadcasting systems utilize a composite signal including an analog modulated carrier and a plurality of digitally modulated subcarriers. Program content (e.g., audio) can be redundantly transmitted on the analog modulated carrier and the digitally modulated subcarriers. The analog audio is delayed at the transmitter by a diversity delay.

Encoders and decoders are used to facilitate transmitting audio from one location to another location with minimum bandwidth. In particular, it is known that radio station operations take remote audio from a remote audio feed and encode it, e.g., with an MP3 type encoding. The reduced bandwidth encoded signal is sent over the internet to the radio station. Encoding reduces the bandwidth needed to represent the audio signal.

One problem lies in that typically several codecs are used in the course of transmission of audio from an audio source to an audio broadcast receiver, such that digital-to-digital conversion of one encoding to another is required, this leading to so-called transcoding artifacts. Also, the quality of a signal is reduced by encoding and the reduced quality signal will then receive further encoding. For example, a radio station may decode an encoded signal from a remote audio feed which will then be of reduced quality and the reduced quality signal will receive a further encoding at the radio station with the result that transcoding artifacts are introduced because the signal has already been encoded/decoded and thus is of reduced audio quality.

There is thus a need to provide methods and systems that improve the audio quality and reduce transcoding artifacts.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Aspects of the present invention provide for transmitting an audio stream from an audio source under eliminating the need for several encoders/decoders in the full path from the audio source to a radio broadcast receiver. Rather, one codec only is used. Thereby, transcoding artifacts are avoided. At the same time, the bandwidth requirements are lowered.

In an embodiment, a method for transmitting an audio stream is provided. The method comprises providing an audio source remotely located to a digital radio broadcasting system, encoding at the audio source an audio stream with an audio codec resulting in an encoded audio stream, transmitting the encoded audio stream over a computer network to the digital radio broadcasting system, receiving the encoded audio stream and processing the encoded audio stream at the digital radio broadcasting system for broadcast by the digital radio broadcasting system without decoding of the encoded audio stream and broadcasting the encoded audio stream by the digital radio broadcasting system.

In a further embodiment, a system for transmitting an audio stream is provided. The system comprises: an audio source remotely located to a digital radio broadcasting system, the audio source is configured to encode the audio stream with an audio codec and to transmit the resulting encoded audio stream over a computer network to the digital radio broadcasting system. The system comprises further the digital radio broadcasting system, wherein the digital radio broadcasting system is configured to receive the encoded audio stream and to process the encoded audio stream for broadcast without decoding of the encoded audio stream.

In a still further embodiment, a digital radio broadcasting system is provided. The digital radio broadcasting system comprises: an importer unit, an exporter unit, and an exciter engine. The importer unit is configured to receive an encoded audio stream encoded at an audio source remotely located from the digital radio broadcasting system, wherein the encoded audio stream is transmitted from the audio source to the importer unit over a computer network. The importer unit is further configured to transmit the encoded audio stream to the exporter unit without decoding of the encoded audio stream. The exporter unit is configured to receive the encoded audio stream and transmit the encoded audio stream to the exciter engine without decoding of the encoded audio stream. The exciter engine is further configured to broadcast the encoded audio stream.

Accordingly, the very codec that is used for encoding the audio stream at the audio source is maintained throughout the digital radio broadcasting chain, without any intermediate decoding and anew coding within the digital radio broadcasting chain. The coded audio stream is decoded at a broadcast receiver only after having been broadcast by the broadcasting system. This way, transcoding artifacts are avoided while maintaining lower bandwidth requirements.

In an embodiment, the method further comprises receiving the broadcast encoded audio stream by a broadcast receiver, and decoding the encoded audio stream at the receiver using the audio codec. The encoded audio stream is decoded at the broadcast receiver for the first time.

In a further embodiment, the method further comprises transmitting the encoded audio stream over the computer network to an importer unit of the digital radio broadcasting system. The encoded audio stream is received at the importer unit and transmitted from the importer unit to an exporter unit of the digital radio broadcasting system without decoding of the encoded audio stream. Further, the encoded audio stream is received at the exporter unit and transmitted to an exciter engine of the digital radio broadcasting system without decoding of the encoded audio stream. The exciter engine then broadcasts the encoded audio stream which still contains the original codec.

In an embodiment, the encoded audio stream provided by the audio source comprises protocol data units (PDU).

In an embodiment, the encoding step comprises encoding the audio stream with a Hybrid-Digital Codec (HDC). HDC is a proprietary codec used in HD radio. It uses a modified discrete cosine transform audio data compression algorithm.

In an embodiment, the audio stream that is encoded in the encoding step is a secondary program audio stream.

Transmitting the encoded audio stream over a computer network may comprise transmitting the encoded audio stream over the Internet.

### BRIEF DESCRIPTION OF THE DRAWINGS

Throughout the drawings, reference numbers are re-used to indicate correspondence between referenced elements. The drawings are provided to illustrate embodiments of the inventions described herein and not to limit the scope thereof.

FIG. 1 illustrates a block diagram of a transmitter for use in an in-band on-channel (IBOC) digital radio broadcasting system.

FIG. 2 illustrates a block diagram of a system for transmission of an audio stream to a digital radio broadcasting system which is not in accordance with the present invention.

FIG. 3 illustrates a block diagram showing a system for transmission of an audio stream to a digital radio broadcasting system in accordance with the present invention.

FIG. 4 illustrates a handshaking process between an audio client and an importer unit.

### DETAILED DESCRIPTION

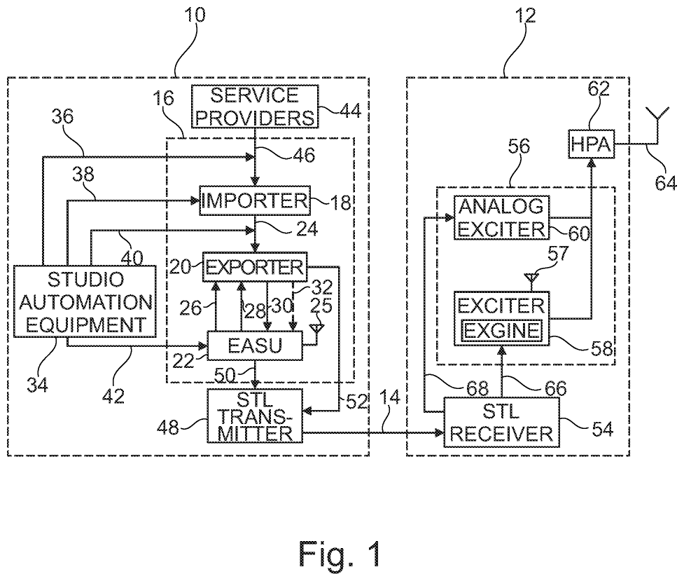

The following description describes various embodiments of methods and systems that provide improved broadcasting of IBOC radio signals. FIG. 1 is a functional block diagram of a portion of the components of a studio site 10, an FM transmitter site 12, and a studio transmitter link (STL) 14 that can be used to broadcast an FM IBOC DAB signal. The studio site includes, among other things, studio automation equipment 34, an Ensemble Operations Center (EOC) 16 that includes an importer 18, an exporter 20, an exciter auxiliary service unit (EASU) 22, and an STL transmitter 48. The transmitter site includes an STL receiver 54, a digital exciter 56 that includes an exciter engine (exgine) subsystem 58, and an analog exciter 60. While in FIG. 1 the exporter 20 is resident at a radio station's studio site and the exciter is located at the transmission site, these elements may be co-located at the transmission site.

At the studio site, the studio automation equipment supplies main program service (MPS) audio 42 to the EASU, MPS data 40 to the exporter, supplemental program service (SPS) audio 38 to the importer, and SPS data 36 to the importer. MPS audio serves as the main audio programming source. In hybrid modes, it preserves the existing analog radio programming formats in both the analog and digital transmissions. MPS data, also known as program service data (PSD), includes information such as music title, artist, album name, etc. Supplemental program service can include supplementary audio content as well as program associated data.

The importer contains hardware and software for supplying advanced application services (AAS). A “service” is content that is delivered to users via an IBOC DAB broadcast, and AAS can include any type of data that is not classified as MPS, SPS, or Station Information Service (SIS). SIS provides station information, such as call sign, absolute time, position correlated to GPS, etc. Examples of AAS data include real-time traffic and weather information, navigation map updates or other images, electronic program guides, multimedia programming, other audio services, and other content. The content for AAS can be supplied by service providers 44, which provide service data 46 to the importer via an application program interface (API). The service providers may be a broadcaster located at the studio site or externally sourced third-party providers of services and content. The importer can establish session connections between multiple service providers. The importer encodes and multiplexes service data 46, SPS audio 38, and SPS data 36 to produce exporter link data 24, which is output to the exporter via a data link.

The exporter 20 contains the hardware and software necessary to supply the main program service and SIS for broadcasting. The exporter 20 accepts digital MPS audio 26 over an audio interface and compresses the audio. The exporter 20 also multiplexes MPS data 40, exporter link data 24, and the compressed digital MPS audio to produce exciter link data 52. In addition, the exporter 20 accepts analog MPS audio 28 over its audio interface and applies a pre-programmed delay to it to produce a delayed analog MPS audio signal 30. This analog audio can be broadcast as a backup channel for hybrid IBOC DAB broadcasts. The delay compensates for the system delay of the digital MPS audio, allowing receivers to blend between the digital and analog program without a shift in time. In an AM transmission system, the delayed MPS audio signal 30 is converted by the exporter 20 to a mono channel signal and sent directly to the STL as part of the exciter link data 52.

The EASU 22 accepts MPS audio 42 from the studio automation equipment, rate converts it to the proper system clock, and outputs two copies of the signal, one digital 26 and one analog 28. The EASU includes a GPS receiver that is connected to an antenna 25. The GPS receiver allows the EASU to derive a master clock signal, which is synchronized to the exciter's clock by use of GPS units. The EASU provides the master system clock used by the exporter 20. The EASU is also used to bypass (or redirect) the analog MPS audio from being passed through the exporter 20 in the event the exporter 20 has a catastrophic fault and is no longer operational. The bypassed audio 32 can be fed directly into the STL transmitter, eliminating a dead-air event.

STL transmitter 48 receives delayed analog MPS audio 50 and exciter link data 52. It outputs exciter link data and delayed analog MPS audio over STL link 14, which may be either unidirectional or bidirectional. The STL link may be a digital microwave or Ethernet link, for example, and may use the standard User Datagram Protocol or the standard TCP/IP.

The transmitter site includes an STL receiver 54, an exciter 56 and an analog exciter 60. The STL receiver 54 receives exciter link data, including audio and data signals as well as command and control messages, over the STL link 14. The exciter link data is passed to the exciter 56, which produces the IBOC DAB waveform. The exciter includes a host processor, digital up-converter, RF up-converter, and exgine subsystem 58. The exgine accepts exciter link data and modulates the digital portion of the IBOC DAB waveform. The digital up-converter of exciter 56 converts from digital-to-analog the baseband portion of the exgine output. The digital-to-analog conversion is based on a GPS clock, common to that of the exporter's GPS-based clock derived from the EASU. Thus, the exciter 56 can include a GPS unit and antenna 57. The RF up-converter of the exciter up-converts the analog signal to the proper in-band channel frequency. The up-converted signal is then passed to the high power amplifier 62 and antenna 64 for broadcast. In an AM transmission system, the exgine subsystem coherently adds the backup analog MPS audio to the digital waveform in the hybrid mode; thus, the AM transmission system does not include the analog exciter 60. In addition, the exciter 56 produces phase and magnitude information and the analog signal is output directly to the high power amplifier.

BOC DAB signals can be transmitted in both AM and FM radio bands, using a variety of waveforms. The waveforms include an FM hybrid IBOC DAB waveform, an FM all-digital IBOC DAB waveform, an AM hybrid IBOC DAB waveform, and an AM all-digital IBOC DAB waveform.

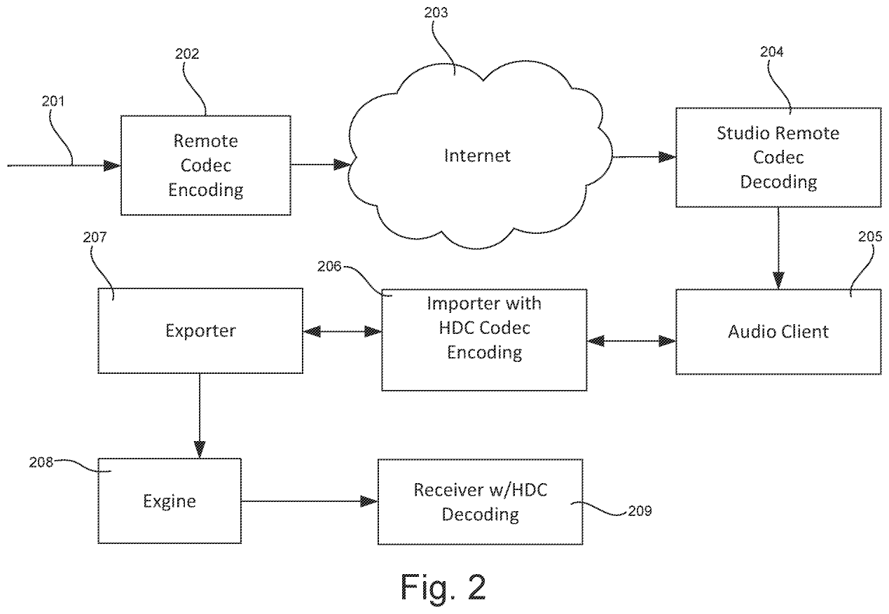

FIG. 2 illustrates a block diagram showing a transmission of an audio stream to a digital radio broadcasting system. In the system of FIG. 2 the present invention is not implemented. However, discussion of that system serves to better understand the background of the present invention.

An audio stream 201 of an audio source which is located remotely from a digital broadcasting system is first encoded. The encoding takes place in a remote encoder 202. The coding is MP3 coding. The encoded audio stream 201 is transmitted over the Internet to a decoder 204 located at a broadcasting system. In decoder 204, the encoded audio stream is decoded with the codec used for the first encoding.

The decoded audio stream is then transmitted to an audio client 205 which may be located at the broadcasting system and transmitted from the audio client 205 to an importer 206 which may be similar to importer 18 of FIG. 1. In importer 206, the audio stream is encoded for a second time. However, now the audio stream 201 is encoded with a second, different codec. The second codec may be the hybrid-digital codec (HD codec), which is a codec special developed for broadcasting audio streams. The HD codec is a lossy audio compression codec.

Subsequently, using an exporter 207 and an exgine 208 the audio stream is broadcast by exgine 208 and received at a broadcast receiver 209. Exporter 207 and exgine 208 may be similar to exporter 20 and exgine 58 of the system of FIG. 1.

Receiver 209 receives the broadcasted and encoded audio stream 201. It comprises a decoder to decode the encoded audio stream with the HD codec that have been used for encoding in importer 206.

The encoding of the audio stream 201 first with a first audio codec in encoder 202, the subsequent decoding of the audio stream, and the second encoding in importer 206 with a second audio codec lead to transcoding artifacts and a reduced audio quality.

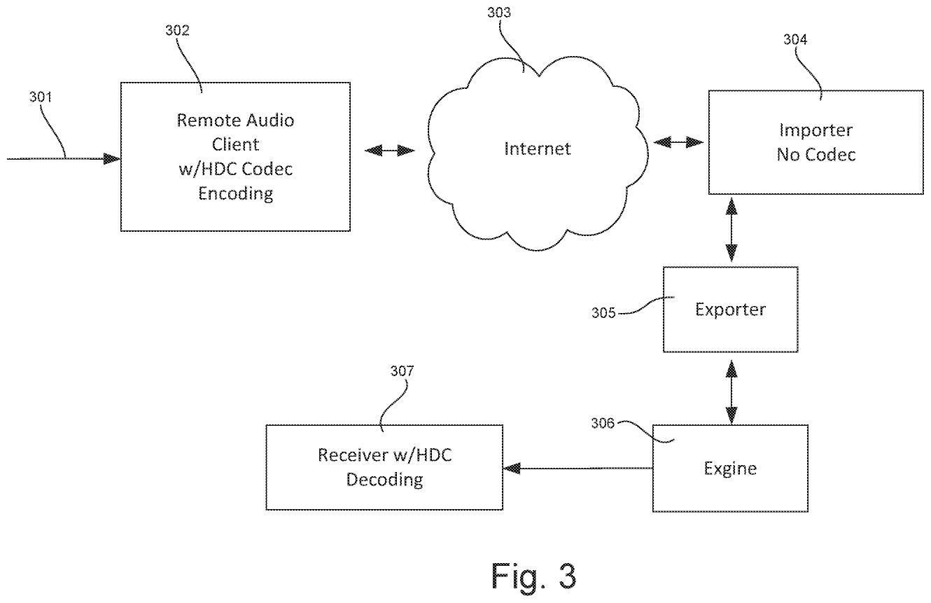

FIG. 3 illustrates a block diagram of a system in accordance with the present invention for transmission of an audio stream to a digital radio broadcasting system and further to a broadcast receiver.

An audio stream 301 of an audio source which is located remotely from a digital broadcasting system is encoded. The encoding takes place in a remote encoder 302. The coding may be by a hybrid-digital codec (HD codec oder HDC). The audio stream 301 may include a main program audio stream and/or a secondary program audio stream (which may correspond to MPS audio and data and SPS audio and data as discussed with respect to FIG. 1). Secondary program audio content is audio content which is not contained in a main program audio stream (MPS). For example, the secondary stream 201 may comprise audio for, e.g., HD2, HD3, etc. in a HD Radio system. In an embodiment, the audio stream 301 is a secondary program audio stream.

The encoded audio stream 301 is transmitted over a computer network such as a packet-switched network such as the Internet 303 to an importer 304 of the broadcasting system. Importer 304 may be similar to importer 18 of the broadcasting system of FIG. 1.

In the transmission from remote encoder 302 to importer 304 no further coding or decoding of the audio stream 301 takes place. Further, importer 304 does not contain any codec for decoding the encoded audio stream 301. Rather, encoder transmits the received audio stream 301 without any decoding to an exporter 305. Exporter 305, which may be similar to exporter 20 of FIG. 1, transmits the audio stream 301 to an exgine 306, which may be similar to exgine 58 of FIG. 1. The manner in which the audio stream is transmitted from exporter 305 to exgine 306 may be similar to that described with respect to FIG. 1.

Exporter 305 does not decode the received encoded audio stream 301. Exporter 305 transmits the encoded audio stream 301 without decoding to exgine 306. In the same manner, exgine 306, before broadcasting the audio stream 301, does not decode or encode the audio stream. The coding of the audio stream is not affected in the complete broadcasting chain.

The broadcast audio stream that includes the original HD codec is received by a broadcast receiver 307. The receiver 307 comprises a decoder which is configured to decode the encoded audio stream 301 with the HD codec.

The entire process of transmitting an encoded original audio stream 301 to a broadcasting system and broadcasting it from the broadcasting system to a broadcast receiver 307 takes place without changing the codec of the original audio stream 301. Only at the receiver 307 the audio stream is decoded. Accordingly, one encoding/decoding of the audio stream 301 takes place only, thereby avoiding transcoding artifacts and a reduction in quality.

Thus, with the present invention, compared to a system as discussed with respect to FIG. 2, at least one step of encoding/decoding is avoided leading to an improved audio quality. Since the avoided encoding/decoding step also comprised an encoding with a lossy audio compression codec, transcoding artifacts are avoided. Further, no taxing links that are commonly used in broadcast radio are needed.

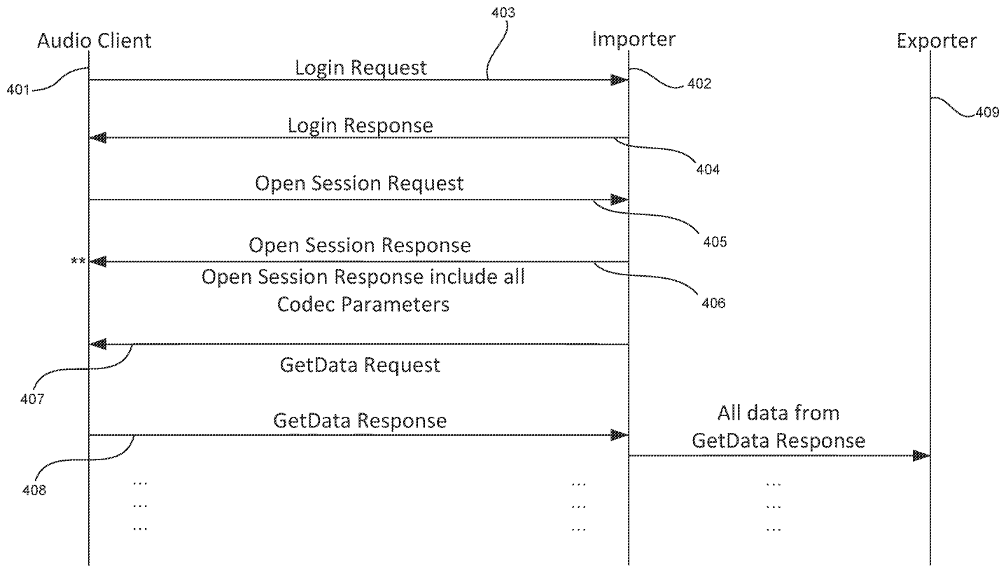

FIG. 4 illustrates a handshaking process which is a process for establishing a connection between two units, in the disclosed embodiment between an audio client 401 and an importer 402. The audio client 401 may include the encoder 302 of FIG. 3 and comprise an audio source or receive data from an audio source. The importer 402 may be similar to importer 304 of FIG. 3 and thus be part of a digital radio broadcasting system. The audio client 401 is remotely located to the digital radio broadcasting system. The audio client 401 communicates with the importer 402 over a computer network such as the Internet.

The audio stream is encoded by audio client 401 with a hybrid-digital codec (HD codec). The HD codec firstly reduces the bandwidth for transmitting the audio stream over the computer network connection and secondly is a codec used for broadcasting audio streams. The specific connection between the audio client 401 and the importer 402 is established by the handshaking process in FIG. 4. The handshaking process comprises parameters which are used to initialize a connection between the audio client 401 and the importer 402 and to operate the codec.

At first a login request 403 is sent by the audio client 401 to the importer 402. The importer unit 402 is configured to send a login response 404 back to the audio client 401. When the audio client 401 is logged in, the audio client 401 sends an open session request 405 to the importer 402. The importer 402 is configured to send an open session response 406 back to the audio client 401. The open session response 406 includes all required codec parameters, namely, the required parameters of the HD codec.

When the session is opened, the importer 402 is configured to send a GetData request 407 to the audio client 401. The audio client 401 sends a GetData response 408 to the importer 402. Subsequently, data of the encoded audio stream are transmitted to the importer 402. All data received by importer unit 402 are transmitted further by the importer unit 402 to the exporter unit 409 of the broadcasting system. The data received from audio client 401 are not decoded, neither at importer 402 nor at exporter 409.

### Alternate Embodiments and Exemplary Operating Environment

Many other variations than those described herein will be apparent from this document. For example, depending on the embodiment, certain acts, events, or functions of any of the methods and algorithms described herein can be performed in a different sequence, can be added, merged, or left out altogether (such that not all described acts or events are necessary for the practice of the methods and algorithms). Moreover, in certain embodiments, acts or events can be performed concurrently, such as through multi-threaded processing, interrupt processing, or multiple processors or processor cores or on other parallel architectures, rather than sequentially. In addition, different tasks or processes can be performed by different machines and computing systems that can function together.

The various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The various illustrative logical blocks and modules described in connection with the embodiments disclosed herein can be implemented or performed by a machine, such as a general purpose processor, a processing device, a computing device having one or more processing devices, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor and processing device can be a microprocessor, but in the alternative, the processor can be a controller, microcontroller, or state machine, combinations of the same, or the like. A processor can also be implemented as a combination of computing devices, such as a combination of a DSP and a microprocessor, a plurality of microprocessors, one or more microprocessors in conjunction with a DSP core, or any other such configuration.

Embodiments of the Left/Right Phase Inversion Detection system and method described herein are operational within numerous types of general purpose or special purpose computing system environments or configurations. In general, a computing environment can include any type of computer system, including, but not limited to, a computer system based on one or more microprocessors, a mainframe computer, a digital signal processor, a portable computing device, a personal organizer, a device controller, a computational engine within an appliance, a mobile phone, a desktop computer, a mobile computer, a tablet computer, a smartphone, and appliances with an embedded computer, to name a few.

Such computing devices can typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, and so forth. In some embodiments the computing devices will include one or more processors. Each processor may be a specialized microprocessor, such as a digital signal processor (DSP), a very long instruction word (VLIW), or other micro-controller, or can be conventional central processing units (CPUs) having one or more processing cores, including specialized graphics processing unit (GPU)-based cores in a multi-core CPU.

The process actions or operations of a method, process, or algorithm described in connection with the embodiments disclosed herein can be embodied directly in hardware, in a software module executed by a processor, or in any combination of the two. The software module can be contained in computer-readable media that can be accessed by a computing device. The computer-readable media includes both volatile and nonvolatile media that is either removable, non-removable, or some combination thereof. The computer-readable media is used to store information such as computer-readable or computer-executable instructions, data structures, program modules, or other data. By way of example, and not limitation, computer readable media may comprise computer storage media and communication media.

Computer storage media includes, but is not limited to, computer or machine readable media or storage devices such as Bluray discs (BD), digital versatile discs (DVDs), compact discs (CDs), floppy disks, tape drives, hard drives, optical drives, solid state memory devices, RAM memory, ROM memory, EPROM memory, EEPROM memory, flash memory or other memory technology, magnetic cassettes, magnetic tapes, magnetic disk storage, or other magnetic storage devices, or any other device which can be used to store the desired information and which can be accessed by one or more computing devices.

A software module can reside in the RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an application specific integrated circuit (ASIC). The ASIC can reside in a user terminal. Alternatively, the processor and the storage medium can reside as discrete components in a user terminal.

The phrase “non-transitory” as used in this document means “enduring or long-lived”. The phrase “non-transitory computer-readable media” includes any and all computer-readable media, with the sole exception of a transitory, propagating signal. This includes, by way of example and not limitation, non-transitory computer-readable media such as register memory, processor cache and random-access memory (RAM).

The phrase “audio signal” is a signal that is representative of a physical sound.

Retention of information such as computer-readable or computer-executable instructions, data structures, program modules, and so forth, can also be accomplished by using a variety of the communication media to encode one or more modulated data signals, electromagnetic waves (such as carrier waves), or other transport mechanisms or communications protocols, and includes any wired or wireless information delivery mechanism. In general, these communication media refer to a signal that has one or more of its characteristics set or changed in such a manner as to encode information or instructions in the signal. For example, communication media includes wired media such as a wired network or direct-wired connection carrying one or more modulated data signals, and wireless media such as acoustic, radio frequency (RF), infrared, laser, and other wireless media for transmitting, receiving, or both, one or more modulated data signals or electromagnetic waves. Combinations of the any of the above should also be included within the scope of communication media.

Further, one or any combination of software, programs, computer program products that embody some or all of the various embodiments of the Left/Right Phase Inversion Detection system and method described herein, or portions thereof, may be stored, received, transmitted, or read from any desired combination of computer or machine-readable media or storage devices and communication media in the form of computer executable instructions or other data structures.

Embodiments of the Left/Right Phase Inversion Detection system and method described herein may be further described in the general context of computer-executable instructions, such as program modules, being executed by a computing device. Generally, program modules include routines, programs, objects, components, data structures, and so forth, which perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the scope of the disclosure. As will be recognized, certain embodiments of the inventions described herein can be embodied within a form that does not provide all of the features and benefits set forth herein, as some features can be used or practiced separately from others.

1. A method for transmitting an audio stream, the method comprising:
providing an audio source remotely located to a digital radio broadcasting system;
encoding at the audio source an audio stream with an audio codec resulting in an encoded audio stream;
transmitting the encoded audio stream over a computer network to the digital radio broadcasting system;
receiving the encoded audio stream and processing the encoded audio stream at the digital radio broadcasting system for broadcast by the digital radio broadcasting system without decoding of the encoded audio stream; and
broadcasting the encoded audio stream by the digital radio broadcasting system.

2. The method of claim 1, wherein the method further comprises
receiving the broadcast encoded audio stream by a receiver; and
decoding the encoded audio stream at the receiver using the audio codec.

3. The method of claim 1, wherein the method further
comprises
transmitting the encoded audio stream over the computer network to an importer unit of the digital radio broadcasting system;
receiving the encoded audio stream at the importer unit and transmitting the encoded audio stream from the importer unit to an exporter unit of the digital radio broadcasting system without decoding of the encoded audio stream;
receiving the encoded audio stream at the exporter unit and transmitting the encoded audio stream to an exciter engine of the digital radio broadcasting system without decoding of the encoded audio stream, the exciter engine broadcasting the encoded audio stream.

4. The method of claim 1, wherein the encoded audio stream provided by the audio source comprises protocol data units (PDU).

5. The method of claim 4, wherein the encoding step comprises encoding the audio stream with a Hybrid-Digital Coding (HDC).

6. The method of claim 1, wherein the audio stream that is encoded in the encoding step is a secondary program audio stream.

7. The method of claim 1, wherein transmitting the encoded audio stream over a computer network comprises transmitting the encoded audio stream over the Internet.

8. A system for transmitting an audio stream, the system comprising:
an audio source remotely located to a digital radio broadcasting system; the audio source configured to encode the audio stream with an audio codec and to transmit the resulting encoded audio stream over a computer network to the digital radio broadcasting system; and
the digital radio broadcasting system, wherein the digital radio broadcasting system is configured to receive the encoded audio stream and to process the encoded audio stream for broadcast without decoding of the encoded audio stream.

9. The system of claim 8, wherein the system further comprises
a receiver configured to receive the broadcast encoded audio stream and to decode the encoded audio stream using the audio codec.

10. The system of claim 8, wherein
the audio source is configured to transmit the encoded audio stream over the computer network to an importer unit of the digital radio broadcasting system,
the importer unit is configured to receive the encoded audio stream and transmit the encoded audio stream to an exporter unit of the digital radio broadcasting system without decoding of the encoded audio stream,
the exporter unit is configured to receive the encoded audio stream and transmit the encoded audio stream to an exciter engine unit of the digital radio broadcasting system without decoding of the encoded audio stream, wherein the exciter engine is further configured to broadcast the encoded audio stream.

11. The system of claim 8, wherein the audio source is configured to encode the audio stream with a Hybrid-Digital Coding (HDC).

12. The system of claim 8, wherein the audio stream that is encoded in the encoding step is a secondary program audio stream.

13. A digital radio broadcasting system comprising:
an importer unit, an exporter unit, and an exciter engine; wherein
the importer unit is configured to receive an encoded audio stream encoded at an audio source remotely located from the digital radio broadcasting system, wherein the encoded audio stream is transmitted from the audio source to the importer unit over a computer network;
the importer unit is further configured to transmit the encoded audio stream to the exporter unit without decoding of the encoded audio stream;
the exporter unit is configured to receive the encoded audio stream and transmit the encoded audio stream to the exciter engine without decoding of the encoded audio stream; and
the exciter engine is further configured to broadcast the encoded audio stream.

14. The digital radio broadcasting system of claim 13, wherein the encoded audio stream transmitted from the audio source to the importer unit comprises protocol data units (PDU).

15. The digital radio broadcasting system of claim 14, wherein the audio stream received by the importer unit is encoded with a Hybrid-Digital Coding (HDC).
